(19) United States
(12) Patent Application Publication
(10) Pub. No.: US 2015/0026229 A1
(43) Pub. Date: Jan. 22, 2015

(54) METHOD IN AN ELECTRONIC DEVICE FOR CONTROLLING FUNCTIONS IN ANOTHER ELECTRONIC DEVICE AND ELECTRONIC DEVICE THEREOF

(71) Applicant: Samsung Electronics Co, Ltd., Gyeonggi-do (KR)

(72) Inventors: Ji-Ryang CHUNG, Gyeonggi-do (KR); Chang-Sook Sung, Gyeonggi-do (KR); Na-Rae Jo, Seoul (KR)

(73) Assignee: Samsung Electronics Co., Ltd.

(21) Appl. No.: 14/334,038

(22) Filed: Jul. 17, 2014

(30) Foreign Application Priority Data
Jul. 17, 2013 (JP) 10-2013-0083952

(51) Int. Cl. H04L 29/08

(52) U.S. Cl. CPC H04L 67/025
USPC 709/201

(57) ABSTRACT

A method in an electronic device for controlling functions in another electronic device, and the electronic device thereof are provided. The method includes receiving, by a first electronic device, a message including control information corresponding to at least one function broadcasted or multicasted from a second electronic device; and performing at least one function corresponding to at least part of information in the message.

### PRIORITY

This application claims priority under 35 U.S.C. §119 to a Korean Patent Application filed in the Korean Intellectual Property Office on Jul. 17, 2013 and assigned Serial No. 10-2013-0083952, the contents of which are incorporated herein by reference.

### BACKGROUND OF THE INVENTION

1. Field of the Invention

The present invention generally relates to an electronic device, and more particularly, to a method of controlling functions in another electronic device.

2. Description of the Related Art

As multimedia technologies and integrated circuit technologies develop, electronic devices providing various multimedia functions are becoming more and more miniaturized and have become an individual's essential device. Furthermore, as electronic devices provide various enhanced services such as Internet data communication, video playback, audio playback, messenger service, schedule management, and alarm functions in addition to a voice communication function via mobile communication, various programs using the functions are used and input methods using programs installed in the electronic devices have also become more varied. Additionally, as short range wireless communication technologies of electronic devices continue to develop, new methods of controlling the electronic devices through wireless communication are provided.

### SUMMARY OF THE INVENTION

The present invention has been made to substantially solve at least the above problems and/or disadvantages and to provide at least the advantages below. Accordingly, an aspect of the present invention is to provide a method and electronic device for transmitting/receiving data through short range wireless communication.

Another aspect of the present invention is to provide a method and electronic device for controlling peripheral electronic devices through simple data transmission.

Another aspect of the present invention is to provide a method and electronic device for synchronizing transmitted/received data.

According to an aspect of the present invention, a control method is provided and includes receiving, by a first electronic device, a message including control information corresponding to at least one function broadcasted or multicasted from a second electronic device; and performing at least one function corresponding to at least part of information in the message.

According to another aspect of the present invention, a method is provided and includes generating, by a first electronic device, a message including at least one identification information on the first electronic device and control information corresponding to at least one function performed in a second electronic device; and multicasting or broadcasting the message.

According to another aspect of the present invention, an electronic device is provided and includes a memory storing identification information and control information, and at least one processor managing a control message, wherein the processor receives a message including at least one of control information corresponding to at least one function by broadcasted or multicasted from a second electronic device and the identification information identifying the second electronic device, and is set to perform at least one function corresponding to at least part of information in the message.

According to another aspect of the present invention, a non-transitory computer readable recording medium having recorded thereon a program which when executed performs an operation of obtaining at least one of user information and environmental information and an operation of determining an operation mode of an electronic device corresponding to at least one of the user information and the environmental information according to a property of the information, wherein the program includes an instruction for receiving a message including control information corresponding to at least one function broadcasted or multicasted from another electronic device and performing at least one function corresponding to at least part of information in the message.

### BRIEF DESCRIPTION OF THE DRAWINGS

The above and other aspects, features and advantages of the present invention will become more apparent from the following detailed description when taken in conjunction with the accompanying drawings in which:

FIG. 1 is a block diagram illustrating a configuration of an electronic device according to an embodiment of the present invention;

FIGS. 2A and 2B illustrate an operation of a first electronic device to transmit/receive data for controlling another electronic device according to an embodiment of the present invention;

FIG. 3 is a diagram illustrating data transmitted and received in an electronic device according to an embodiment of the present invention;

FIG. 4 is a diagram illustrating a data configuration in an electronic device according to an embodiment of the present invention;

FIG. 5 is a diagram illustrating a data configuration in an electronic device according to an embodiment of the present invention;

FIGS. 6A and 6B are diagrams illustrating a data configuration in an electronic device according to an embodiment of the present invention;

FIG. 7 is a diagram illustrating a data configuration in an electronic device according to an embodiment of the present invention;

FIG. 8 is a diagram illustrating an operation of a first electronic device to process data received from a second electronic device according to an embodiment of the present invention;

FIGS. 9A and 9B are screen views illustrating an operation of displaying a data processing result in an electronic device according to an embodiment of the present invention;

FIG. 10 is a flowchart illustrating an operation of processing data in an electronic device according to an embodiment of the present invention; and

FIGS. 11A to 11C are flowcharts illustrating operations of processing data in an electronic device according to various embodiments of the present invention.

### DETAILED DESCRIPTION OF EMBODIMENTS OF THE PRESENT INVENTION

Hereinafter, embodiments of the present invention will be described in more detail with reference to the accompanying drawings. In the following description, detailed descriptions of well-known functions or constructions will be omitted since they would obscure the invention in unnecessary detail. Also, the terms used hereinafter are defined according to the functions of the present invention. Thus, the terms may vary depending on a user's or operator's intentions or practices. Therefore, the terms used herein must be understood based on the descriptions made herein.

In describing various embodiments of the present invention, an electronic device is described based on a touch screen performing an input operation through an input device and a display operation on a physical screen. Although a display unit and an input device are separated from each other in a device configuration according to an embodiment of the present invention, the display unit may include the input device or the input device may include the display unit.

The present invention is not limited to an electronic device including a touch screen, and a display unit and an input device may be physically separated from each other, or an electronic device including only one of a display unit and an input device may be provided. According to various embodiments below, a device displayed as a touch screen may be an electronic device including a display unit input device, which does not include a touch input device including a touch input device and a display unit.

In the description below, the electronic device 100 may include mobile communication user devices, PDAs, PC laptops, smart phones, smart TVs, netbooks, Mobile Internet Devices (MIDs), Ultra Mobile PCs (UMPCs), Tablet PCs, mobile pads, media players, handheld computers, navigation systems, smart watches, Head Mounted Displays (HMDs), and MP3s.

In this disclosure below, when one part (or element, device, etc.) is referred to as being “connected” to another part (or element, device, etc.), it should be understood that the former can be “directly connected” to the latter, or ‘electrically connected’ to the latter via an intervening part (or element, device, etc.). On the contrary, when one part is referred to as being “directly connected” to another part, it should be understood the there is no intervening part.

According to an embodiment of the present invention, as power consumption for short range wireless communication is reduced through BLE technology, various operations of portable electronic devices including a limited capacity of a battery, for example, sports, health care, sensing, and control devices, are possible.

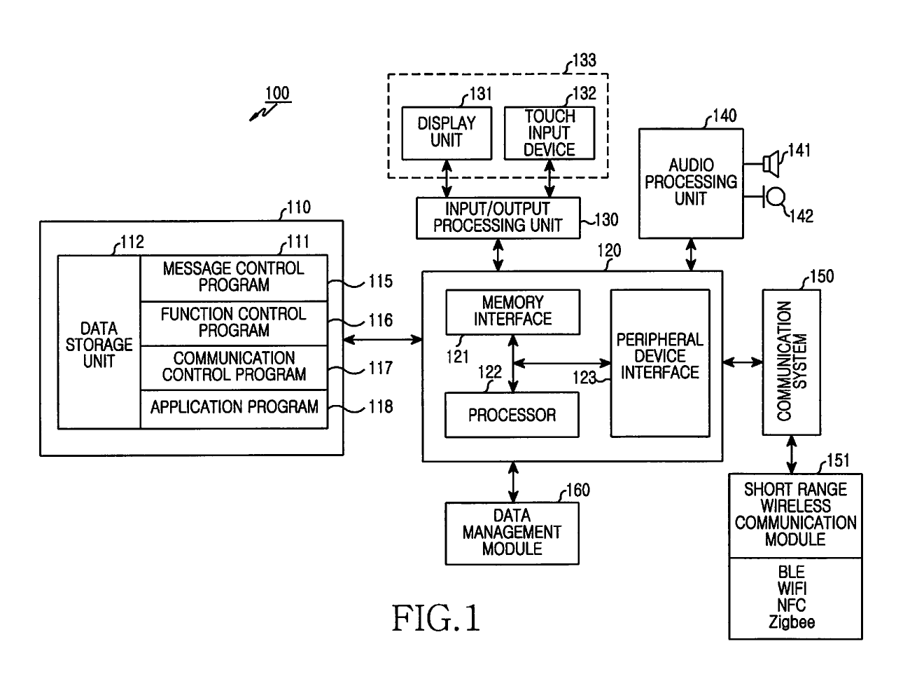

FIG. 1 is a block diagram illustrating a configuration of an electronic device according to an embodiment of the present invention. As shown in FIG. 1, the electronic device 100 includes a memory 110, a processor unit 120, and peripheral devices such an input/output processing unit 130, a display unit 131, an input device, an audio processing unit 140, and a communication system 150.

The memory 110 includes a program storage unit 111 storing a program for controlling an operation of the electronic device 100 and a data storage unit 112 storing data generated during program execution, and also may store data generated from a program during an operation of the processor 122. According to an embodiment of the present invention, the data storage unit 112 may configure and store a table or a list form of database by determining operation information in advance, which is used for allowing the electronic device 100 to control another electronic device.

According to an embodiment of the present invention, the data storage unit 112 may configure and store a whitelist for at least one another electronic device assigned with an authority for controlling the electronic device 100 in a table or a list form of database.

According to an embodiment of the present invention, the data storage unit 112 may configure and store a table or a list form of database by setting an authorized operation for a control of another electronic device in each electronic device included in an authorized electronic device list.

The program storage unit 111 includes a message control program 115, a function control program 116, a communication control program 117, and at least one application program 118. Programs included in the program storage unit 111 may be configured with a set of instructions and expressed in an instruction set. The application program 118 may include a software component for at least one application program installed in the electronic device 100.

When the electronic device 100 configures data (for example, packet data), the message control program 115 obtains a command for controlling a pre-agreed another electronic device with reference to the database of the electronic device 100. The electronic device 100 may configure data (for example, packet data) including control information configured with an instruction for controlling some operations of another electronic device to be controlled and identification information of the electronic device 100. The identification information may include an identification (ID) for identifying the electronic device 100.

When receiving data (for example, packet data) that another electronic device broadcasts via short range wireless communication, the message control program 115 obtains the identification code of another electronic device and an instruction (or control information) for controlling some operations of the electronic device 100.

The function control program 116 determines whether the identification code of another electronic device and an instruction (or control information) for controlling some operations of the electronic device 100 obtained from data received with reference to a database is an authorized identification code and authorized control information.

The function control program 116 performs operations of the electronic device 100 according to an instruction for controlling some operations of an electronic device that corresponds to control information with reference to a database.

The communication control program 117 includes at least one software component for controlling communication with at least another electronic device through the communication system 150 or the short range wireless communication module 151. According to an embodiment of the present invention, the communication control program 117 may search for another electronic device for communication connection. If another electronic device for communication connection is found, the communication control program 117 sets communication connection with another electronic device. Then, the communication control program 117 controls the transmission of data such as packet data with another electronic device through the communication system 150 by performing performance search and session establishment procedure with another connected electronic device.

According to an embodiment of the present invention, the communication control program 117 may transmit data such as packet data within a predetermined network group or a predetermined channel range without setting the communication connection with another electronic device. When transmitting data within a predetermined network group or a predetermined channel range without setting the communication connection with another electronic device, the electronic device 100 may receive data transmitted from another electronic device because the other electronic device is located within the predetermined network group or the predetermined channel range.

The memory 110 included in the electronic device 100 may be configured with at least one of program storage unit 111 and data storage unit 112. The electronic device 100 may include at least one memory 110 as a module. According to an embodiment of the present invention, the memory may only function as the program storage unit 111 and may only function as the data storage unit 112 according to a purpose of the electronic device 100, and may function as both. A physical area division in the memory 110 may not be clearly configured due to the characteristics of an electronic device.

The processor unit 120 includes a memory interface 121, at least one processor 122, and a peripheral device interface 123. Here, the memory interface 121, at least one processor 122, and the peripheral device interface 123 in the processor unit 120 may be integrated as at least one circuit or may be implemented with separate components.

The memory interface 121 controls an access to the memory 110 for a component such as the processor 122 or the peripheral device interface 123.

The peripheral device interface 123 controls a connection of the processor 122 and the memory interface 121 with an input/output peripheral device 133 of the electronic device 100.

The processor 122 allows the electronic device 100 to provide various multimedia services through at least one software program, to confirm a UI operation of the electronic device 100 through the display unit 131, and to provide a service for receiving an instruction from the outside of the electronic device 100 through the touch input device 132. The processor 122 may provide a service corresponding to a corresponding program by executing at least one program stored in the memory 110.

The input/output processing unit 130 provides an interface between the input/output device such as a touch input device 132 and the peripheral device interface 123.

The display unit 131 receives state information of the electronic device 100, externally inputted characters, moving images, and still images from the processor unit 120, configures a UI operation, and then displays it through the input/output processing unit 130.

The touch input device 132 provides input data generated by a user's selection to the processor unit 120 through the input/output processing unit 130. According to an embodiment of the present invention, the touch input device 132 may be configured only with a control button or a keypad to receive data for control from the outside of the electronic device 100.

According to an embodiment of the present invention, the touch input device 132 provides input/output to the display unit 131 and the input/output device 133 to allow the input/output on one screen. In such a case, the touch input device 132 used by the input/output device 133 may use at least one type of a capacitive type, a resistive film (pressure sensing) type, an infrared type, an electromagnetic induction type, and an ultrasonic type.

According to an embodiment of the present invention, an input type of the touch input device 132 may use a processing method of inputting a command if an input means is located within a predetermined distance from the touch screen 133, in addition to an input method of directly touching the direct touch screen 133, and may use terms such as hovering touch, floating touch, indirect touch, proximity touch, and non-contact input.

The input/output device 133, as a device combining the touch input device 132 with one screen on the display unit 131 physically, may be a touch screen for inputting an instruction by touching a screen configuration displayed on the display unit 131 during an operation of the electronic device 100. Since the touch screen is capable of performing the roles of the display unit 131 displaying an UI operation of the electronic device 100 and the touch input device 132 inputting an external instruction to the electronic device 100, the display unit 131 and the touch input device 132 may together configure the touch screen 133. According to an embodiment of the present invention, the touch screen 133 configured with a multi touch panel including a touch panel and a pen touch panel is described herein. The touch screen 133 of the electronic device 100 is not limited to a touch screen configured with a multi touch panel and may be applied to a touch screen including a pen touch available panel.

The audio processing unit 140 provides an audio interface between a user and the electronic device 100 through a speaker 141 and a microphone 142.

The communication system 150 performs a communication function. According to an embodiment of the present invention, the communication system 150 performs communication with another electronic device through at least one of a mobile communication base station, a wired communication, and a satellite communication, and may perform short range wireless communication in connection with a short range wireless communication module.

According to an embodiment of the present invention, the short range wireless communication module 151 may perform communication with another electronic device through at least one of short range wireless communication (for example, Infrared Data Association (IrDA) communication, Bluetooth communication, Bluetooth Low Energy (BLE) communication, Wireless Fidelity (WiFi) communication, Near Field Communication (NFC) wireless communication, and Zigbee communication), Wireless Local Area Network (WLAN) communication, and wired communication. The communication system 150 and the short range wireless communication module 151 are separately described, but they may be performed as one communication system module.

The data management module 160 may be a module set for performing at least one of functions of the message control program 115 or the function control program 116, and may be controlled by a processor. According to an embodiment of the present invention, the electronic device 100 receives data including control information corresponding to at least one function broadcasted or multi-casted from another electronic device through the processor 122 and the identification information for identifying another electronic device, and may control the data management module 160 to perform at least one function corresponding to at least part of the data.

In describing an embodiment of the present invention, a display on the electronic device 100 or an output to the electronic device 100 may be a term representing a method of displaying a moving image, a still image, or a GUI operation on the touch screen input/output device 133 of the electronic device 100, or outputting a signal sound or a voice audio to the speaker 141. A term referring to a display or an output may be used as having the same meaning in the description below, and may be separately described if a distinction is required.

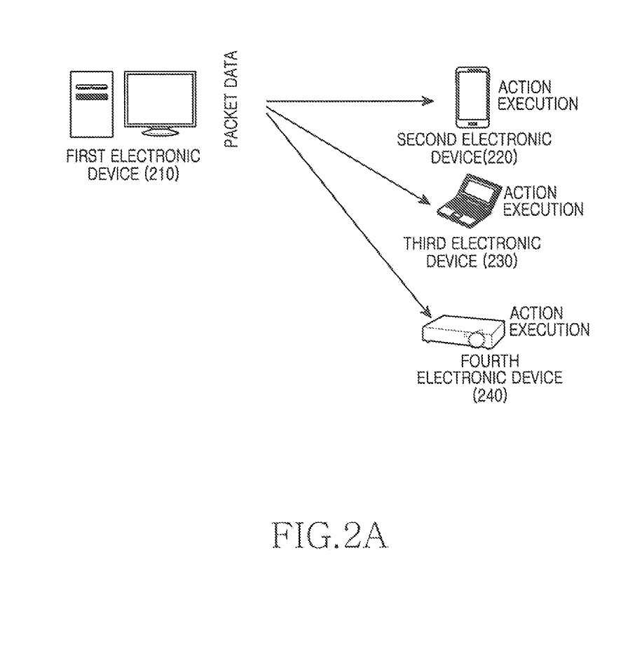

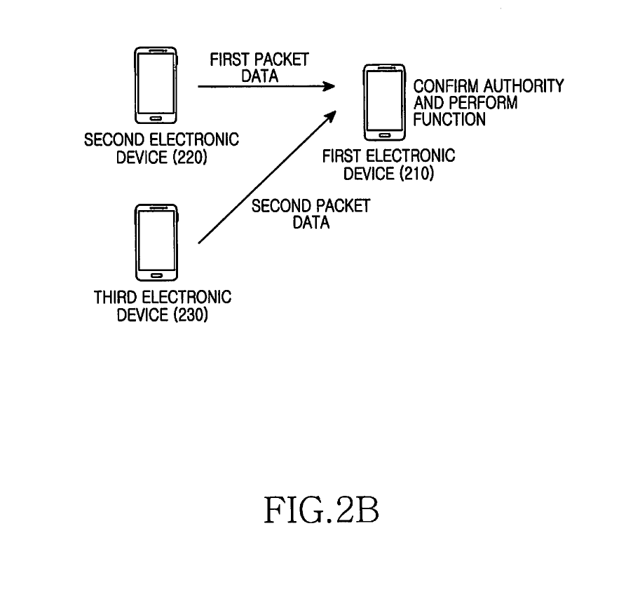

FIGS. 2A and 2B are views illustrating operations for transmitting/receiving data for controlling another electronic device (for example, a second electronic device, a third electronic device, or a fourth electronic device) by a first electronic device (for example, the electronic device 100 of FIG. 1) according to various embodiments of the present invention. The first electronic device 210 may generate data, such as packet data, including an instruction for controlling an action to be performed in the second electronic device 220 and the identification code of the first electronic device 210, and may transmit (for example, broadcasting, multicasting, or unicasting) data within an effective range of short range wireless communication. According to an embodiment of the present invention, the first electronic device 210 may scan and receive data, such as packet data, transmitted from the second electronic device 220 within an effective range of short range wireless communication, and may perform an action according to the database of the first electronic device 210 with reference to the identification code and control information included in the received data.

Referring to FIG. 2A, the first electronic device 210 generates data including the identification code ID and an instruction for controlling an action and broadcasts the data within a predetermined range through short range wireless communication. The broadcasting may be a data transmission in which data are not transmitted to a specific target but transmitted to unspecified targets in the same or different network group. According to an embodiment of the present invention, the first electronic device 210 may determine that the second electronic device 220 receives an action (or data such as packet data) to be performed in the first electronic device 210. The electronic device 210 may generate data including an action name for controlling a determined action, control information such as action parameter, and the identification code of the first electronic device 210, and the data may be data having standards for transmission through short range wireless communication. The first electronic device 210 may broadcast the generated data through short range wireless communication according to a period predetermined by the first electronic device 210.

Here, the control information may configure a database including a predetermined instruction (that is, an instruction for performing an action) between two electronic devices so as to allow the second electronic device 220 to determine a function or an operation of the second electronic device 220 by using information obtained from data generated and transmitted from the first electronic device 210, and may store the database in the memory of the first electronic device 210 and the second electronic device 220.

The second electronic device 220 scans a short range wireless communication range according to a predetermined period, and receives data broadcasted from the first electronic device 210. According to an embodiment of the present invention, the second electronic device 220 may obtain the identification code and action name of the first electronic device 210 and control information such as an action parameter included in the received data, and may determine whether the identification code of the first electronic device 210 transmitting the data is included in a list of devices permitted for executing the control information with reference to a database stored in the memory of the second electronic device 220.

If it is determined that the identification code of the first electronic device 210 is authorized through the database, the second electronic device 220 performs a function or operation of the first electronic device 210 according to the control information included in the data.

Like the second electronic device 220, the third electronic device 230 and the fourth electronic device 240 may include a database having pre-agreed instructions with the first electronic device 210, receive data broadcasted from the first electronic device 210, obtain the identification code and control information of the first electronic device 210, and perform a function and operation corresponding to the control information in the case of the authorized identification code.

The first electronic device 210 may broadcast data including identification code and control information within a short range wireless communication range, and may perform one consistent operation according to a control through the second, third, and fourth electronic devices 220, 230, and 240 including the same database.

Referring to FIG. 2B, the first electronic device 210 may receive data such as packet data broadcasted from the second electronic device 220 through short range wireless communication and may perform an action in the first electronic device 210 with reference to instruction information for controlling an ID and action in the data. According to an embodiment of the present invention, the first electronic device 210 scans and receives first data broadcasted from the second electronic device 220 and obtains the identification code and control information of the second electronic device 220 included in the first data. The first electronic device 210 determines whether the identification code of the second electronic device 220 is identification code through information on a database stored in the memory 110. If it is confirmed that the identification code of the second electronic device 220 is unauthorized identification code, the first electronic device 210 may not perform an action according control information included in the first data.

According to an embodiment of the present invention, the first electronic device 210 may receive second data broadcasted from the third electronic device 230 and may obtain the identification code and control information of the second electronic device 230 included in the second data. The first electronic device 210 determines whether the identification code of the third electronic device 230 is authorized identification code through information on a database stored in the memory 110. If it is confirmed that the identification code of the second electronic device 230 is unauthorized identification code, the third electronic device 230 may perform an action according control information included in the second data.

If it is determined that the identification code of the first electronic device 210 is authorized identification code, the first electronic device 210 performs an action corresponding to control information included in the second data or determines the authorized control information of the second data. According to an embodiment of the present invention, the first electronic device 210 may include a database such as ‘authorized control information on the third electronic device 230’ in the memory 110 and may determine the control information of the second data authorized by the first electronic device 210 among control information of the second data.

The first electronic device 210 may perform an action corresponding to control information authorized with reference to the database of the first electronic device 210 among control information of the second data.

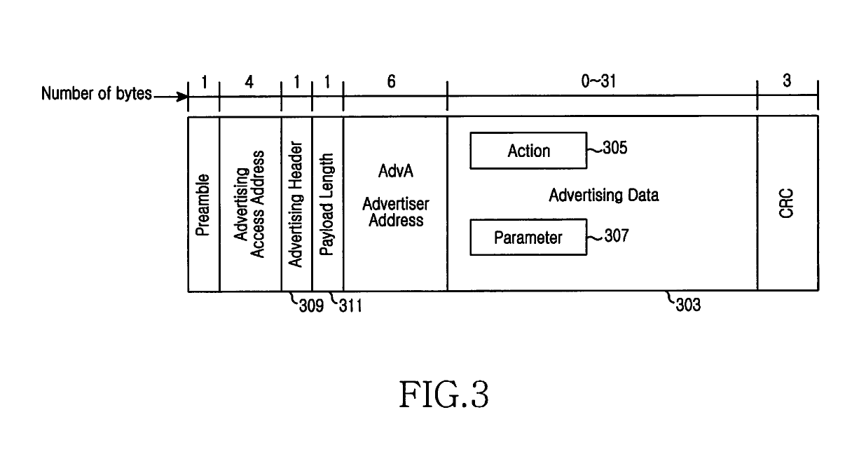

FIG. 3 is a diagram illustrating data transmitted and received in an electronic device according to an embodiment of the present invention. The first electronic device 210 broadcasts data, such as packet data, through wireless communication. In order to perform an instruction included in the data through the second electronic device 220 when the first electronic device 210 broadcasts the data under a wireless communication environment, the identification code of the first electronic device 210 and an instruction (for example, control information) for performing a function of the second electronic device 220 may be included in the data.

Referring to FIG. 3, data used for wireless communication in the first electronic device 210 includes an area including identification (ID) information and an area including control information. According to an embodiment of the present invention, when data is broadcasted, the first electronic device 210 includes an identification code pre-agreed with the second electronic device 220 receiving the data in an advertiser address area 303 configured with 6 bytes.

According to an embodiment of the present invention, the first electronic device 210 includes control information for controlling some functions of the second electronic device 220 in an advertizing data area 303 configured with 31 bytes by using an instruction pre-agreed with the second electronic device 220 receiving data.

The first electronic device 210 includes control information for controlling a function of at least one second electronic device 220 in the advertizing data area 303, control information by dividing control information into a plurality of data when the size of the control information exceeds 31 bytes, and generates a plurality of data by including an instruction used for confirming that control information is included in a plurality of advertizing data areas 303, (that is, a plurality of data configure one complete control information), in an advertizing header area 309 or payload length area 311 configured with 1 byte. The first electronic device 210 transmits complete control information by broadcasting a plurality of data. According to an embodiment of the present invention, the advertizing data area may include an action area 305 configured with an instruction for a function of the second electronic device 220 to be controlled and a parameter area 307 configured with an instruction for controlling a detailed operation for a function and information may be included therein.

The data configured with about 47 bytes shown in FIG. 3 is not limited to the above data size or area size of FIG. 3, and also the data of FIG. 3 such as the advertiser address 303 or the advertizing data 303 is not limited to the above configuration of FIG. 3 and may be applied to various data used in a wireless communication environment

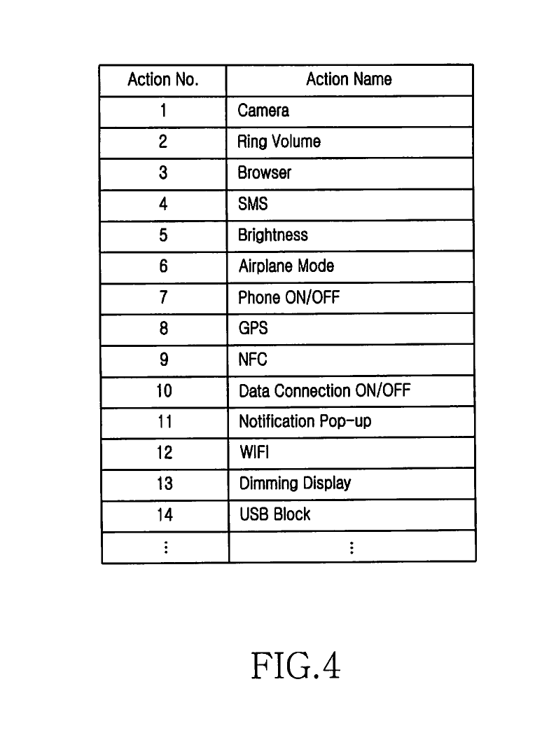

FIG. 4 is a diagram illustrating a data configuration in an electronic device (for example, the electronic device 100 of FIG. 1) according to an embodiment of the present invention. In order to generate data (for example, packet data) including an instruction for allowing the first electronic device 210 to perform an action of the second electronic device 220, the first electronic device 210 configures an action database including a pre-agreed instruction for performing an action of the second electronic device 220 in a table or list form between the first electronic device 210 and the second electronic device 220. The pre-agreed instruction may include a pre-defined rule between an electronic device broadcasting data in a protocol format and the second electronic device 220 receiving data.

Referring to FIG. 4, the first electronic device 210 generates and broadcasts data including an instruction for performing an action in the second electronic device 220, and includes an instruction for controlling a function or operation of the second electronic device 220 in the memory 110 in order to perform an action on the basis of control information in data through the second electronic device 220 receiving the data.

The action number of the second electronic device 220 in a database stored in the memory 110 of the first electronic device 210 may be an instruction code for representing information corresponding to an action name controlled in the second electronic device 220.

The database information of the first electronic device 210 is not limited to an action number or an action name but also may include information on an action parameter and a parameter value. According to an embodiment of the present invention, when the first electronic device 210 allows the second electronic device 220 to execute a browser and move to a specific web page, the database may further include data about information on an action number (for example, 3 of FIG. 4), an action name (for example, browser of FIG. 4), an action parameter (for example, whether to move to a specific webpage), and a parameter value (for example, a specific webpage address).

The action number is not limited to information such as the number shown in FIG. 4, and may be a code combining at least one of a symbol, a number, or a character, which are pre-agreed upon between the first electronic device 210 broadcasting data and the second electronic device 220 receiving data. According to an embodiment of the present invention, information such as a action parameter and a parameter value included in a database may be configured with a code combining at least one of a symbol, a number, or a character, which are pre-agreed upon between the first electronic device 210 and the second electronic device 220, in order to control an action of the second electronic device 220.

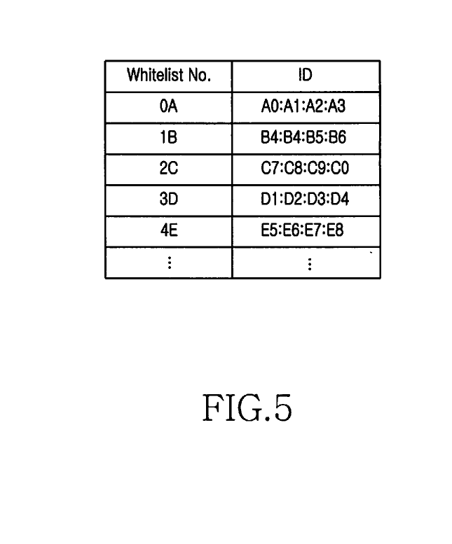

FIG. 5 is a diagram illustrating a data configuration in an electronic device (for example, the electronic device 100 of FIG. 1) according to an embodiment of the present invention. The first electronic device 210 may receive data (for example, packet data) broadcasted from the second electronic device 220 and the data may include the identification code of the second electronic device 220 transmitting data. The first electronic device 210 determines whether the second electronic device 220 transmitting data in order to perform an action corresponding to control information included in the data is authorized. The first electronic device 210 configures an identification code database by using a list of devices authorized for performing an action in the data in a table or list format and stores the identification database in the memory 110. The first electronic device 210 determines whether the second electronic device 220 transmitting data is authorized with reference to the authorized device list. According to an embodiment of the present invention, the first electronic device 210 may obtain the identification code A0:A1:A2:A3 and control information of the second electronic device 220 transmitting data from the received data, and when a list of authorized devices in a database includes the identification code A0:A1:A2:A3, the second electronic device 220 including the identification code A0:A1:A2:A3 is determined to be an authorized device. The first electronic device 210 includes the identification code of an authorized device in the database and also assigns a unique number Whitelist No. to the identification code, so that it may control the size of data during data transmission with the second electronic device 220.

According to an embodiment of the present invention, the identification code stored in the list of authorized devices whitelist may be a 6 byte advertiser address in the case of an advertising packet of BLE communication. If it is determined that the second electronic device 220 is authorized, the first electronic device 210 performs an action corresponding to control information included in the data.

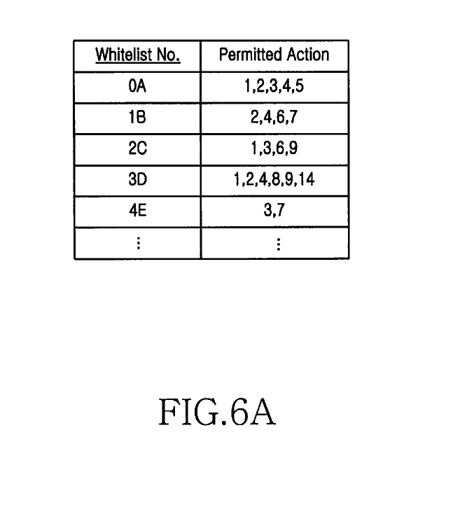

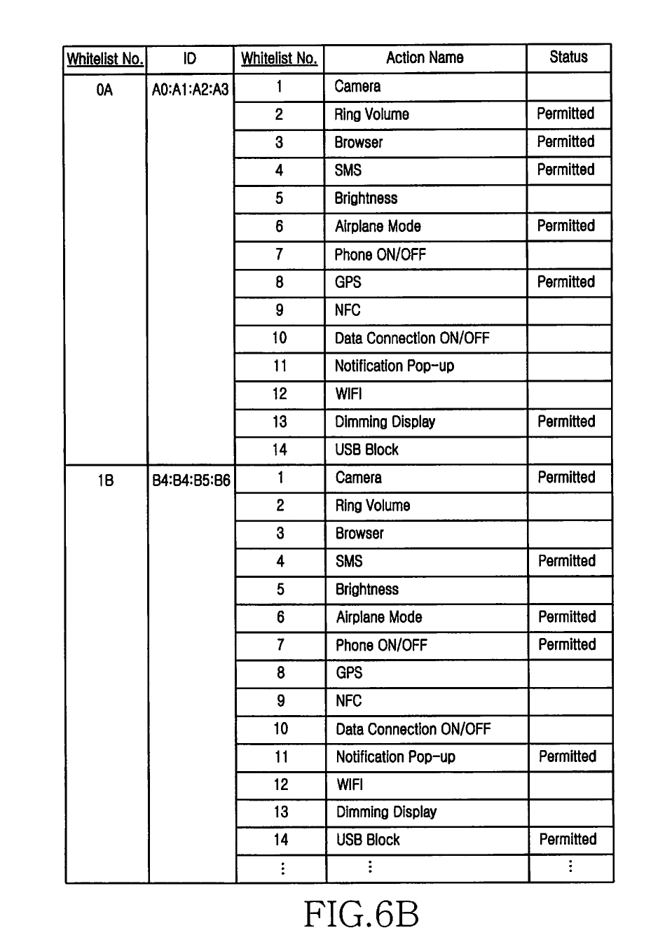

FIGS. 6A and 6B illustrate a data configuration in an electronic device (for example, the electronic device 100 of FIG. 1) according to an embodiment of the present invention. The first electronic device 210 receives data broadcasted from the second electronic device 220 and determines whether an action of the first electronic device 210 to be controlled based on control information obtained from the data is an authorized action. The first electronic device 210 stores a list for authorization for controlling an action of an electronic device in a mapping database in a table or list form, and stores the mapping database in the memory 110 of the first electronic device 210. According to an embodiment of the present invention, the first electronic device 210 configures a list of other electronic devices having an authority to control an action of an electronic device and stores the list in a memory. Other electronic devices capable of controlling an action of an electronic device may determine a whitelist number for classification and may establish a database for whitelist by mapping a whitelist number into the identification code or authorized action of another electronic device.

Referring to FIG. 6A, the first electronic device 210 configures a mapping data by setting an authorized action to each authorized device so as to control an action. Mapping data may be configured using the whitelist number of an authorized device and the action number of an authorized action. According to an embodiment of the present invention, with reference to a whitelist number in the mapping data of the first electronic device 210, whitelist numbers of devices capable of controlling the first electronic device 210 may be 0A, 1B, 2C, 3D, and 4E. It is confirmed that the device identification code corresponding to a device 0A is A0:A1:A2:A3 through an identification code database and actions authorized for control may have action numbers 1, 2, 3, 4, and/or 5. Referring to an action database (see FIG. 4), it is confirmed that an action corresponding to an Action Number 1 among authorized actions is a camera. An electronic device may configure a mapping database with whitelist numbers and authorized actions through the above method.

According to an embodiment of the present invention, a component of a mapping database of the first electronic device 210 is not limited to a whitelist number and may use an identification code, and also is not limited to an action number. Like the method of using an action name, the component may be determined through a predetermined method between the first electronic device 210 transmitting/receiving data and other devices. According to an embodiment of the present invention, a whitelist number may be defined as a code representing a range (for example, short range wireless communication service area) in which devices corresponding to an identification code broadcast data through short range wireless communication.

Referring to FIG. 6B, the first electronic device 210 may configure a mapping database including a variety of information without being limited to FIG. 6A through a method of configuring a mapping database. The mapping database of the first electronic device 210 may include whitelist numbers or identification codes of devices authorized for controlling some actions of the first electronic device 210. Additionally, the mapping database may list actions that the first electronic device 210 is capable of providing with respect to the whitelist number or identification code of each device in a table or list form, and may configure a database through a manner of setting a state in which a control is authorized for each provided action. According to an embodiment of the present invention, the mapping database of FIG. 6B includes whitelist numbers of devices controlled to perform an action of the first electronic device 210 through control information of data (for example, packet data). When the device 0A is included as one of devices authorized for controlling the first electronic device 210 in a mapping database, the mapping database includes an IDentification code A0:A1:A2:A3 of a device corresponding to the Whitelist Number 0A in addition to the Whitelist Number 0A. When only one of the IDentification code A0:A1:A2:A3 or the Whitelist Number 0A of a device transmitting data is confirmed from the data that the first electronic device 210 receives, it is determined that a control of the first electronic device is authorized with reference to the mapping database of FIG. 6B.

According to an embodiment of the present invention, the mapping database may set actions authorized for control in information on actions that the first electronic device 210 provides with respect to each identification code or whitelist number of a device authorized for controlling some actions of the first electronic device 210.

According to an embodiment of the present invention, the mapping database of FIG. 6B includes information on a device (Whitelist Number 0A or IDentification code A0:A1:A2:A3) authorized for controlling some actions of the first electronic device 210 through control information of data (for example, packet data). The authorized device (Whitelist Number 0A or IDentification code A0:A1:A2:A3) may include information on some actions for controlling the first electronic device 210. Only actions having action numbers 2, 3, 4, 6, 8 and/or 13 among some actions may be set as control-authorized actions according to the control information of the device having Whitelist Number 0A.

Referring to FIG. 6B, if the first electronic device 210 receives data broadcasted from the second electronic device 220 and IDentification Code A0:A1:A2:A3, among control information obtained from the data (for example, packet data), controls of actions such as Ring Volume action No. 2, Browser action No. 3, Social Media Service (SMS) action No. 4, Airplane Mode action No. 6, Global Positioning System (GPS) action No. 8 and/or Dimming Display action No. 13 that the first electronic device 210 provides may be authorized and may limit the control to not perform unauthorized actions.

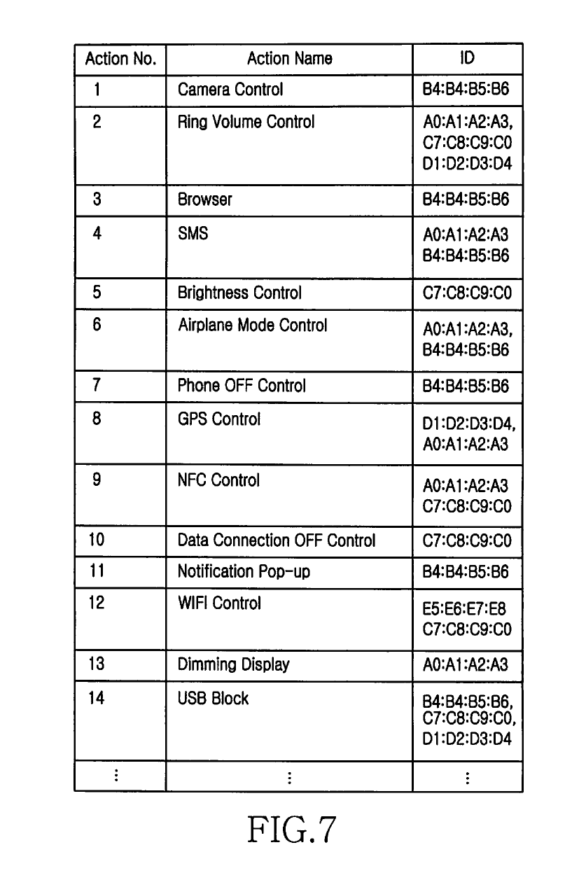

FIG. 7 is a diagram illustrating a data configuration in an electronic device (for example, the electronic device 100 of FIG. 1) according to an embodiment of the present invention. The mapping database may be configured by setting devices capable of controlling each action provided from the first electronic device 210. According to an embodiment of the present invention, the mapping database of FIG. 7 includes information such as Action No. and Action Name on actions provided from the first electronic device 210. When an action provided from the first electronic device 210 includes Ring Volume action No. 2, the mapping database sets and stores ID codes A0:A1:A2:A3, C7:C8:C9:C0, and D1:D2:D3:D4 as devices authorized for controlling the Ring Volume action No. 2 through data (for example, packet data).

The first electronic device 210 may receive data (for example, packet data) and may obtain the IDentification code (or whitelist number) and control information of a device broadcasting the data, from the data. If a device transmitting data is an authorized device corresponding to ID code D1:D2:D3:D4 with reference to the mapping data of FIG. 7, the first electronic device 210 may authorize controls only for Ring Volume action No. 2, GPS action No. 8, and/or USB Block action No. 14.

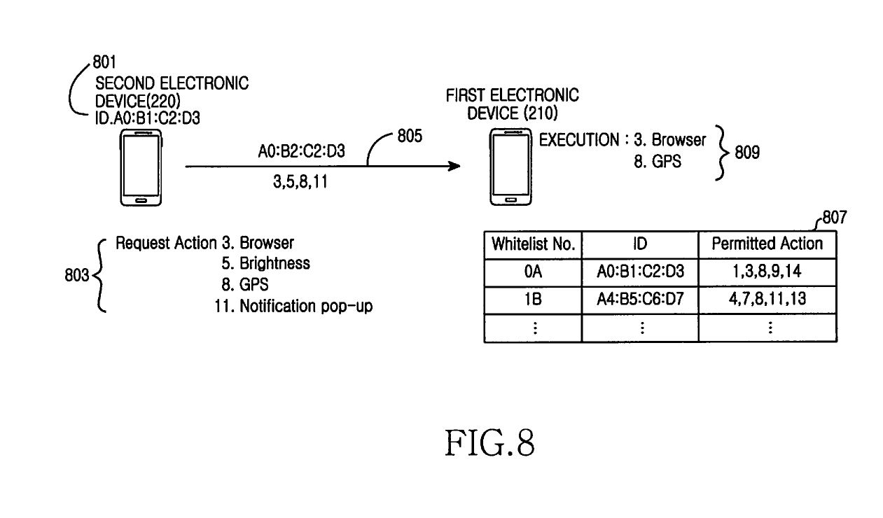

FIG. 8 is a diagram illustrating an operation of processing data received from the second electronic device 220 in the first electronic device 210 according to an embodiment of the present invention. Referring to FIG. 8, the first electronic device 210 generates and broadcasts data (for example, packet data) to control at least one electronic device within a short range wireless communication range.

The first electronic device 210 receives data (for example, packet data) and obtains the IDentification code (or whitelist number, hereinafter referred to as an IDentification code) and control information of the second electronic device 220 transmitting data (for example, packet data). The first electronic device 210 determines whether the second electronic device 220 corresponding to an IDentification code is a device authorized for controlling the first electronic device 210 by using the identification code of data with reference to a database stored in the memory 110. If the second electronic device 220 is determined as an authorized device, actions authorized for control are determined from the control information with reference to a database. The first electronic device 210 performs a function or operation thereof according to control information with respect to control-authorized actions. According to an embodiment of the present invention, when trying to control the browser, brightness, GPS, and notification pop-up actions of the first electronic device 210 within a short range wireless communication range, the second electronic device 220 generates data including the IDentification code 801 A0:A1:A2:A3 and the information 803 on Action Numbers 3, 5, 8, and 11 defined in an action database of the second electronic device 220. The first electronic device 210 broadcasts the generated data 805 through short range wireless communication.

The first electronic device 210 receives data (for example, packet data) broadcasted from the second electronic device 220 through short range wireless communication scanning and obtains the IDentification code 801 and the control information 805 of the second electronic device 220 included in the data. The first electronic device 210 confirms that the second electronic device 220 is an authorized electronic device with reference to the database 807 in the memory 110 and confirms that a control is authorized on Actions 3 and 8 among actions having Action Numbers 3, 5, 8, and 11 included in the control information. The first electronic device 210 performs a control 809 on Browser action No. 3 and GPS action No. 8 corresponding to the authorized Actions 3 and 8 according to the control information of data.

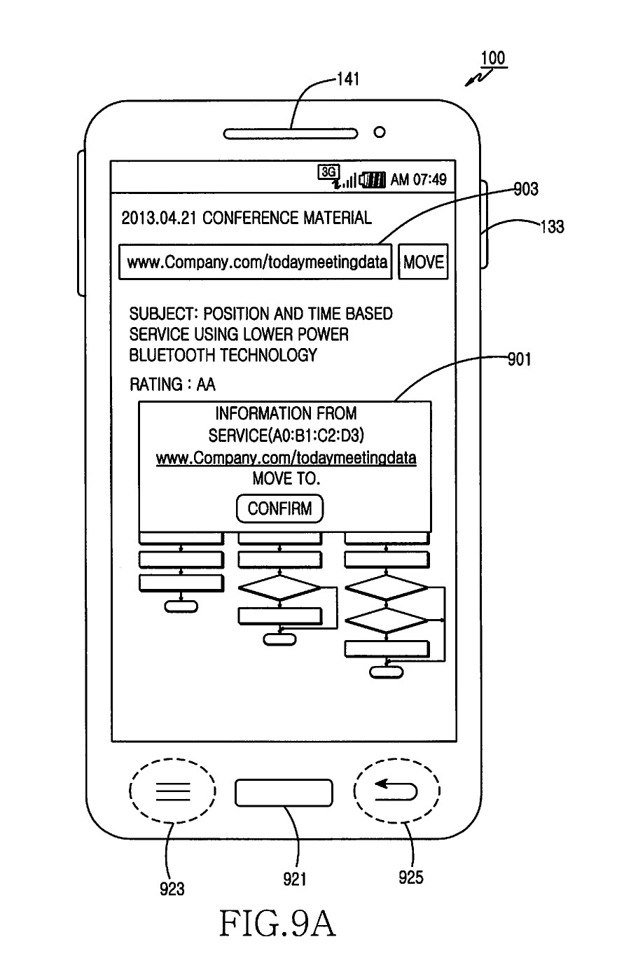

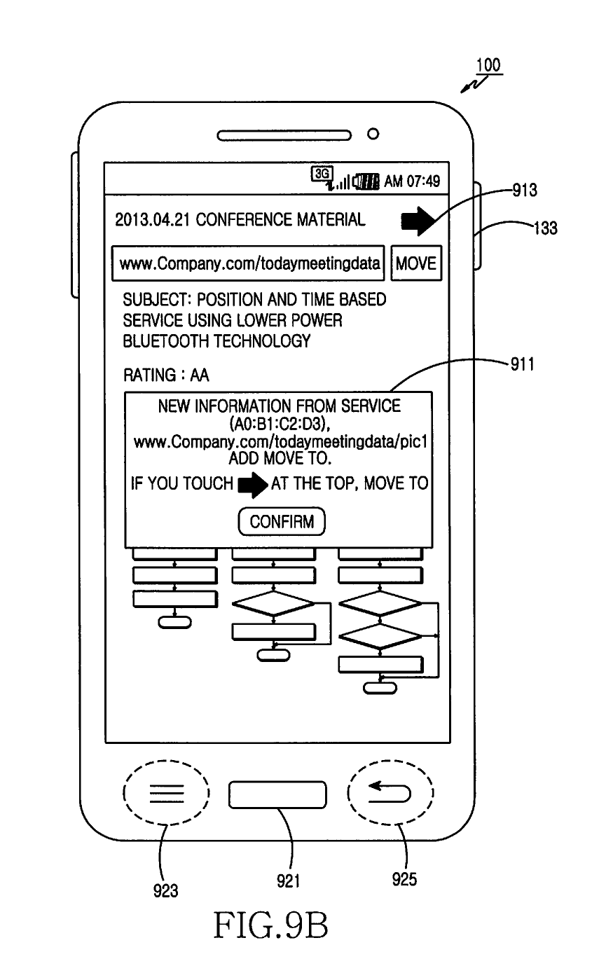

FIGS. 9A and 9B illustrate screen views of an operation of displaying a data processing result in an electronic device (for example, the electronic device 100 of FIG. 1) according to an embodiment of the present invention. According to an embodiment of the present invention, the first electronic device 210 includes a touch screen 133 at a front part. The touch screen 133 includes the display unit 131 for displaying content on an operation of the first electronic device 210 as a UI and the touch input device 132 for inputting an instruction by dragging the first input means on the touch screen 133 or moving a first input means being spaced a predetermined distance apart from the touch screen 133. According to an embodiment of the present invention, a speaker 141 for outputting sound is included at the top of the first electronic device 210, and a button 921, i.e. one of input devices for inputting an instruction by clicking, is included at the bottom of the first electronic device 210, and a touch button 923 or 925 for inputting an instruction through touch may be included at fixed positions adjacent to button 921. According to an embodiment of the present invention, the speaker 141, the button 921, or the touch button 923 or 925 of the first electronic device 210 may be located at the same or different position.

Referring to FIG. 9A, the first electronic device 210 receives data (for example, packet data) broadcasted from the second electronic device 220 and obtains the control information on IDentification code A0:A1:A2:A3, browser and notification pop-up control of the second electronic device 220. The first electronic device 210 confirms the IDentification code A0:A1:A2:A3 with reference to a database stored in the memory 110 and determines an action authorized for control information browser control and notification pop-up control. The first electronic device 210 executes a browser according to control information and may perform an Internet page move (parameter) action 903 by using the address (parameter value) www.company.com/todaymeetingdata through a browser according to a parameter and a parameter value included in the control information. The first electronic device 210 may display the browser, the moved internet page address 903, and content on the touch screen 133 or another display unit (not shown) of the first electronic device 210 according to a performed result, and may display the notification pop-up 901 for displaying the control of data received from the second electronic device 220 according to the control information. According to an embodiment of the present invention, the first electronic device 210 is not limited to a notification for the control of data received from the second electronic device 220 according to control information displayed by configuring a UI and displaying it on the touch screen 133 or another display unit (not shown). Thus, the notification may be outputted as sound through the speaker 141 and may be outputted through a vibration of the first electronic device 210.

The first electronic device 210 receives data (for example, packet data) broadcasted from the second electronic device 220 and obtains the IDentification code and control information. With reference to a database stored in a memory of the first electronic device 210, it is determined whether the second electronic device 220 corresponding to IDentification code is an authorized device and if the second electronic device 220 is an authorized device, an authorized action is controlled according to control information.

Referring to FIG. 9B, the first electronic device 210 receives data (for example, packet data) broadcasted from the second electronic device 220 by scanning the data periodically and obtains the control information on IDentification code A0:A1:A2:A3, changed browser control, and changed notification pop-up control of the second electronic device 220 from the received data. The first electronic device 210 confirms the IDentification code A0:A1:A2:A3 with reference to a database stored in the memory 110 and determines an action authorized for changed control information browser control and notification pop-up control. The first electronic device 210 executes a browser according to control information and performs an Internet page move action by using the address (parameter value) www.company.com/todaymeetingdata/pic1 through a browser according to a parameter and a parameter value included in the changed control information. The first electronic device 210 may display an icon for moving to an Internet page address changed through touch on the touch screen 133 of the first electronic device 210 or another display unit (not shown) according to a performed result and may display a notification pop-up displaying that a control of changed data received from the second electronic device 220 is added according to control information. According to an embodiment of the present invention, the first electronic device 210 is not limited to a notification for the control of data received from the second electronic device 220 according to control information displayed by configuring a UI and displaying it on the touch screen 133 or another display unit (not shown). Thus, the notification may be outputted as sound through the speaker 141 and may be outputted through a vibration of the first electronic device 210.

The second electronic device 220 generates data (for example, packet data) including changed control information when an instruction for allowing the first electronic device 210 to perform an operation is changed and broadcasts the data within a short range wireless communication range. The first electronic device 210 receives data broadcasted from the second electronic device 220 through scanning, obtains the identification code and control information, and applies changed control information.

According to various embodiments, the first electronic device 210 may include a processor for managing a control message, a memory for storing identification information and control information, and at least one processor. The electronic device 100 receives a message including at least one of the control information corresponding at least one function broadcasted or multi-casted from the second electronic device 220 through the processor and the identification information for identifying the second electronic device 220 and performs at least one function corresponding to at least some information included in the message.

According to various embodiments, the first electronic device 210 generates data including at least one identification information on the first electronic device 210 and control information corresponding to at least one function performed by the second electronic device 220, and multicasts or broadcasts data to a plurality of other electronic devices as a target.

According to various embodiments, the first electronic device 210 obtains at least one of user information or environment information and stores it in a memory, and stores a program for executing an operation of determining a mode of an electronic device in a memory corresponding to at least one of user information or environment information according to the property of content. The program includes an instruction for receiving data including control information corresponding to at least one function broadcasted or multi-casted from the second electronic device 220 and for performing at least one function corresponding to at least some information in the received data.

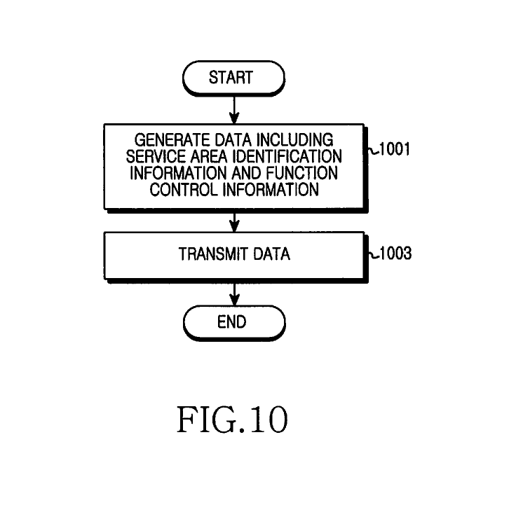

FIG. 10 is a flowchart illustrating a data processing operation in an electronic device (for example, the electronic device 100 of FIG. 1) according to various embodiments of the present invention. The first electronic device 210 transmitting/receiving data configures information on a data transmission possible range through short range wireless communication as service area information. According to an embodiment of the present invention, when data is transmitted/received through Bluetooth communication, a data transmission possible range through Bluetooth communication may be service area information of Bluetooth communication.

According to an embodiment of the present invention, unique information for managing the service area information of Bluetooth communication may be defined and included in service area information. The service area information includes the whitelist number of a short range wireless communication range in which the first electronic device 210 broadcasts data (for example, packet data) through short range wireless communication. The IDentification code of the first electronic device 210 generating and broadcasting data is included in the service area information.

The first electronic device 210 generates data (for example, packet data) including an IDentification code for identifying the first electronic device 210 or an IDentification code for identifying a service area and control information for controlling at least one function of the second electronic device 220 and broadcasts the generated data through short range wireless communication.

In step 1001, the first electronic device 210 generates data (for example, packet data) including service area information and function control information.

The service area information included in the data is used for determining an authority of the data that the second electronic device 220 receives. If it is determined that the IDentification code of the first electronic device 210 is authorized (or permitted) with reference to the IDentification code of a database included in a memory of the second electronic device 220, the IDentification code of the first electronic device 210 is used for determining whether to perform an action according to control information in the data. The first electronic device 210 transmits/receives data within a communication range of short range wireless communication (for example, BLE) and includes service area information on a position at which the data is transmitted through short range wireless communication, an area where the data is transmitted, and the first electronic device 210 transmitting the data.

Function control information (or control information) may be an instruction for controlling the first electronic device 210 broadcasting data (for example, packet data) so that the second electronic device 220 receiving the data performs some function thereof. According to an embodiment of the present invention, the second electronic device 220 receiving data may perform some actions in control information in the data and may change a function of the second electronic device 220 that the first electronic device 210 controls according to information in the data. With reference to a database of the second electronic device 220, if the first electronic device 210 has an authority to change the setting of the second electronic device 220, the first electronic device 210 configures the data including information on an action of the second electronic device 220 to be controlled.

In step 1003, the first electronic device 210 broadcasts or transmits the generated data through short range wireless communication or allows the second electronic device 220 receiving the data to perform an action of pre-agreed function control information in the data.

When the first electronic device 210 has authority to change the database of the second electronic device 220, according to information included in the data that the first electronic device 210 transmits, information on the area of the first electronic device 210 authorized for a change from the database of the second electronic device 220 is reset.

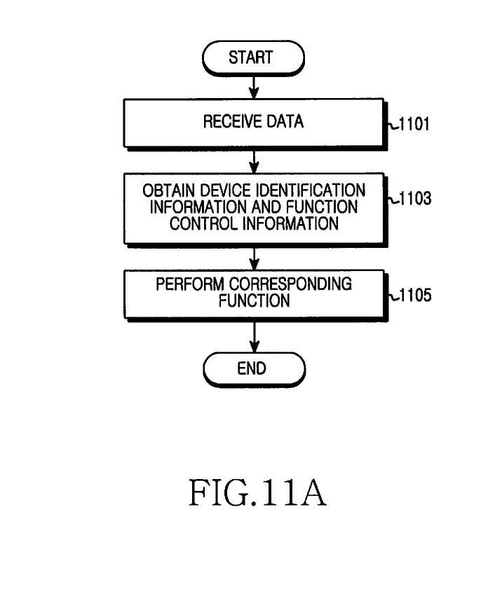

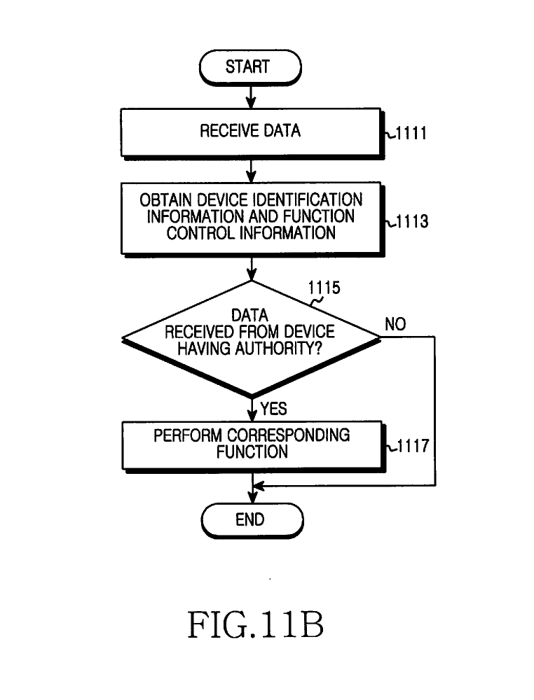

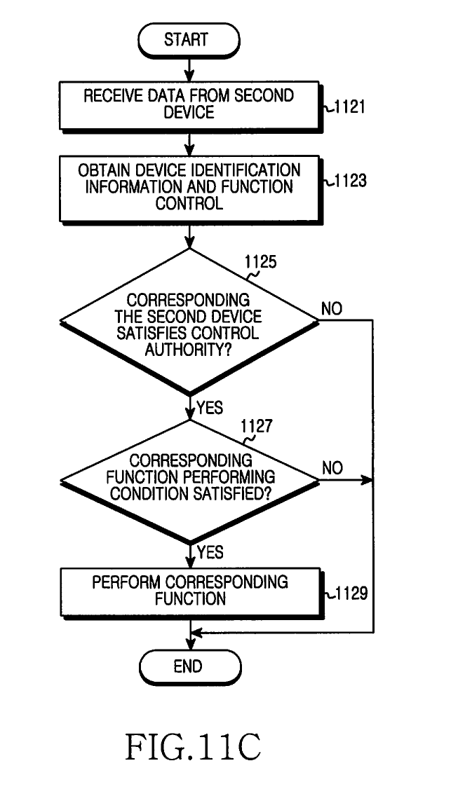

FIGS. 11A to 11C are flowcharts illustrating a data processing operation in an electronic device (for example, the electronic device 100 of FIG. 1) according to an embodiment of the present invention. Referring to FIG. 11A, the first electronic device 210 receives data (for example, packet data) broadcasted from the second electronic device 220 through short range wireless communication, obtains the identification information (for example, ID or service area information) and function control information of the second electronic device 220 from the data, and performs all or some actions of the function control information according to information set in the database of the first electronic device 210.

In step 1101, the first electronic device 210 receives data broadcasted from the second electronic device 220 through periodic scanning in short range wireless communication.

According to an embodiment of the present invention, when a BLE communication method, one of short range wireless communication methods, is used, the first electronic device 210 receives data broadcasted from the second electronic device 220 by periodically scanning a network group (for example, a predetermined frequency or channel) through which the second electronic device 220 broadcasts the data.

The first electronic device 210 is not limited to the BLE communication method and thus may transmit/receive data (for example, packet data) through a short range wireless communication method such as NFC communication, WiFi communication, or Zigbee communication.

In step 1103, the first electronic device 210 obtains control information such as the IDentification code of the first electronic device 210, an action name, and an action parameter included in the received data.

With reference to a database including an instruction pre-agreed to with the second electronic device 220, the first electronic device 210 confirms control information such as an action name or an execution code for controlling the first electronic device 210 in the received data.

In step 1105, the first electronic device 210 performs an action according to function control information obtained from the received packet information.

According to an embodiment of the present invention, the second electronic device 220 allows the first electronic device 210 to perform an action through function control information in data (for example, packet data). An instruction in function control information may be an instruction processed by the first electronic device 210, and the first electronic device 210 performs an action that the second electronic device 220 controls according to an instruction of the function control information.

Referring to FIG. 11A, according to an embodiment of the present invention, the second electronic device 220 capable of transmitting a BLE broadcaster (for example, BLE packet data may be installed at a theater, a cinema or an exhibition, and data including function control information for adjusting a ring volume to 0 (that is, mute) may be generated, and data may be broadcasted periodically to a BLE communication service area through BLE communication. When the first electronic device 210 enters a BLE service area of the second electronic device 220, it receives data transmitted from the second electronic device 220. The first electronic device 210 obtains the IDentification information (for example, ID) of the second electronic device 220 and function control information for adjusting the ring volume to 0 (that is, mute). The first electronic device 210 sets its ring volume to 0 according to function control information. When the first electronic device 210 is out of the BLE service area of the second electronic device 220, the second electronic device 220 adds function control information for restoring the ring volume to its original state to the data and then transmits the data.

Referring to FIG. 11B, the first electronic device 210 receives data (for example, packet data) broadcasted from the second electronic device 220 through short range wireless communication, obtains the IDentification information (for example, ID or service area information) and function control information of the second electronic device 220 from the data, determines whether the second electronic device 220 corresponding to the IDentification information is authorized for controlling the first electronic device 210 with reference to a database, and performs all or some actions of the function control information according to information set in the database of the first electronic device 210.

In step 1111, the first electronic device 210 receives data (for example, packet data) broadcasted from the second electronic device 220 through periodic scanning in short range wireless communication.

According to an embodiment of the present invention, when a BLE communication method, one of short range wireless communication methods, is used, the first electronic device 210 receives data broadcasted from the second electronic device 220 by periodically scanning a network group (for example, a predetermined frequency or channel) through which the second electronic device 220 broadcasts the data.

According to an embodiment of the present invention, the first electronic device 210 is not limited to the BLE communication method and thus may transmit/receive data through a short range wireless communication method such as NFC communication, WiFi communication, or Zigbee communication.

In step 1113, the first electronic device 210 obtains control information such as the IDentification code of the first electronic device 210, an action name, and an action parameter included in the received data.

The first electronic device 210 and the second electronic device 220 configure a database including a pre-agreed upon instruction. According to an embodiment of the present invention, the second electronic device 220 generating the data including an instruction for controlling an action provided from the first electronic device 210 configures function control information with an instruction used in the first electronic device 210 or may configure control information according to a rule pre-agreed upon with the first electronic device 210 such as a protocol format.

According to an embodiment of the present invention, the first electronic device 210 and the second electronic device 220 configure a common database for control information of a function provided from the first electronic device 210 or an instruction for controlling an action in order to control an action provided from the first electronic device 210.

In step 1115, the first electronic device 210 determines whether the received data includes the control authority of the second electronic device 220 by using identification information in the received data with reference to the database included in the memory 110.

According to an embodiment of the present invention, the first electronic device 210 includes IDentification information on at least one second electronic device 220 broadcasting data in the database and assigns an authority for controlling a function of the first electronic device 210 to some or all IDentification information through function control information in the data. The second electronic device 220 corresponding to the authority-assigned IDentification information includes an IDentification code and function control information for allowing the first electronic device 210 to perform some actions in the data and then broadcasts the data. The first electronic device 210 receiving the data determines whether the second electronic device 220 is authorized for controlling an action of the first electronic device 210 with reference to at least one IDentification information of a database and identification information in the data.

In step 1117, if the data is received form a device having authority, the first electronic device 210 performs an action according to function control information obtained from the received packet information. If the data is received from a device not having authority, the process ends.

According to an embodiment of the present invention, the IDentification code of the second electronic device 220 may be an IDentification code authorized for allowing the first electronic device 210 to perform an action. An instruction in the function control information of data may be an instruction processed by the first electronic device 210 and the first electronic device 210 performs an action that the second electronic device 220 controls according to an instruction of the function control information.

Referring to FIG. 11B, according to an embodiment of the present invention, the second electronic device 220 capable of transmitting a BLE broadcaster (for example, BLE packet data) may be installed at a pharmacy or a hospital, and data including function control information for controlling a notification pop-up and the identification information of the second electronic device 220 is generated, and the data is broadcasted periodically to a BLE communication service area through BLE communication. When the first electronic device 210 enters a BLE service area of the second electronic device 220, it periodically receives the data broadcasted from the second electronic device 220. The first electronic device 210 obtains the IDentification information of the second electronic device 220 and function control information for controlling a notification pop-up in the data. The first electronic device 210 determines whether the IDentification code of the second electronic device 220 is an authority-assigned (that is, authorized) IDentification code with reference to a database. If the IDentification code of the second electronic device 220 is an authority-assigned, the first electronic device 210 provides information such as a waiting number, a prescribed medicine preparation completed notification, a doctor schedule or a hospitalization/discharge procedure.

Referring to FIG. 11C, the first electronic device 210 receives data (for example, packet data) broadcasted from the second electronic device 220 through short range wireless communication, obtains the identification information (for example, ID or service area information) and function control information of the second electronic device 220 from the data, determines whether the second electronic device 220 corresponding to the identification information is authorized for controlling the first electronic device 210 with reference to a database, and performs all or some actions of the function control information according to information set in the database of the first electronic device 210.

In step 1121, the first electronic device 210 receives data broadcasted from the second electronic device 220 through periodic scanning in short range wireless communication.

According to an embodiment of the present invention, when a BLE communication method, one of short range wireless communication methods, is used, the first electronic device 210 receives data broadcasted from the second electronic device 220 by periodically scanning a network group (for example, a predetermined frequency or channel) through which the second electronic device 220 broadcasts the data.

According to an embodiment of the present invention, the first electronic device 210 is not limited to the BLE communication method and thus may transmit/receive data through a short range wireless communication method such as NFC communication, WiFi communication, or Zigbee communication.

In step 1123, the first electronic device 210 obtains control information such as the IDentification code of the first electronic device 210, an action name, and an action parameter included in the received data.

The first electronic device 210 and the second electronic device 220 configure a database including a pre-agreed upon instruction. According to an embodiment of the present invention, the second electronic device 220 generating the data including an instruction for controlling an action provided from the first electronic device 210 configures function control information with an instruction used in the first electronic device 210 or configures control information according to a rule pre-agreed upon with the first electronic device 210 such as a protocol format. According to an embodiment of the present invention, the first electronic device 210 and the second electronic device 220 configure a common database for control information of a function provided from the first electronic device 210 or an instruction for controlling an action in order to control an action provided from the first electronic device 210.

In step 1115, the first electronic device 210 determine the control authority of the second electronic device 220 by using IDentification information in the received data with reference to the database included in the memory 110.

According to an embodiment of the present invention, the first electronic device 210 includes identification information on at least one second electronic device 220 broadcasting data (for example, packet data) in the database and assigns an authority for controlling a function of the first electronic device 210 to some or all identification information through function control information in the data. The second electronic device 220 corresponding to the authority-assigned IDentification information includes an IDentification code and function control information for allowing the first electronic device 210 to perform some actions in the data and then broadcasts the data. The first electronic device 210 receiving the data determines whether the second electronic device 220 is authorized for controlling an action of the first electronic device 210 with reference to at least one IDentification information of a database and identification information in the data.

In step 1127, if it is determined that the second electronic device 220 is authorized for controlling an action of the first electronic device 210, the first electronic device 210 determines the control authority of the function control information in the received data with reference to the database included in the memory 110.

According to an embodiment of the present invention, the first electronic device 210 includes at least one authorized IDentification information broadcasting data to the database and sets a controllable action according to the function control information of the data (for example, packet data) with respect to each IDentification information.

The first electronic device 210 determines to perform an action corresponding to authorized control information among control information of the received data with reference to a database.

In step 1129, the first electronic device 210 performs an action corresponding to the authorized function control information.

According to an embodiment of the present invention, some or all function control information in data (for example, packet data) transmitted by the second electronic device 220 may be an IDentification code authorized for allowing the first electronic device 210 to perform an action. An instruction in the authorized function control information may be processed by the first electronic device 210 and the first electronic device 210 may perform an action that the second electronic device 220 controls according to an instruction of the authorized function control information.

Referring to FIG. 11C, according to an embodiment of the present invention, the second electronic device 220 capable of transmitting a BLE broadcaster (for example, BLE packet data) may be installed at a cafe or a store, and data including function control information for displaying an order state or an advertisement through a notification pop-up and the IDentification information of the second electronic device 220 is generated, and the data is broadcasted periodically to a BLE communication service area through BLE communication. When the first electronic device 210 enters a BLE service area of the second electronic device 220, it periodically receives the data (for example, packet data) broadcasted from the second electronic device 220. The first electronic device 210 obtains the IDentification information of the second electronic device 220 and function control information for controlling a notification pop-up in the data. The first electronic device 210 determines whether the IDentification code of the second electronic device 220 is an authority-assigned (that is, authorized) IDentification code with reference to a database. If the IDentification code of the second electronic device 220 is assigned with an authority, the first electronic device 210 determines whether the IDentification code for displaying an order state or an advertisement through a notification pop-up is authority-assigned (that is, authorized) function control information with reference to a database. The first electronic device 210 may determine that the function control information for displaying an order state through a notification pop-up is authorized and the function control information for displaying an advertisement through a notification pop-up is not authorized, with reference to a database. The first electronic device 210 displays an order state through a notification pop-up according to authorized function control information.

Various embodiments illustrating this disclosure may be performed by at least one program in the memory 110 of the electronic device 100, may be directly controlled by a processor, or may be controlled by a data management module receiving an instruction of a processor.

According to various embodiments, an operating method of an electronic device includes an operation of receiving data including IDentification information and control information, an operation of confirming the received data and information pre-stored in a database, and an operation of performing a function corresponding to the control information according to the confirmed result.

According to various embodiments, an operating method of an electronic device includes an operation of generating packet data including IDentification information and control information and an operation of broadcasting the packet data through wireless communication.

According to various embodiments, an electronic device (for example, a first electronic device) may include information on an operation that is controlled through an electronic device (for example, a second electronic device) receiving the data in a limited size of data (for example, packet data) that are transmitted (for example, broadcasting, multicasting, or unicasting). This allows at least one unspecified electronic device (for example, the second electronic device) receiving the data to consistently perform an operation (for example, a function, a menu, or a service) corresponding to the operational information. By changing and transmitting the operational information in the data, an operation of allowing an electronic device (for example, the second electronic device) receiving the data to perform an operation may be updated in real time. Additionally, when an electronic device (for example, the first electronic device) receiving the data broadcast or multicast the data including operational information to a plurality of electronic devices (for example, the second electronic device), by including the ID of the electronic device (for example, the second electronic device) performing an operation corresponding to the operational information in the data and transmitting the data, only some of the plurality of electronic devices (for example, the second electronic device) may perform the operation.

Methods or devices (for example, at least one module) according to various embodiments disclosed in claims or this specification may be implemented using hardware, firmware, software or a combination thereof. At least some of operations (for example, steps 1121 to 1129 of FIG. 11C) mentioned in each method may be performed sequentially, in parallel, or repeatedly, and also some operations may be omitted or new operations may be added.

If the methods are implemented using software, a computer readable recording medium storing at least one program (i.e., a software module) may be provided. At least one program stored in a computer readable recording medium is set for execution by at least one processor in an electronic device. At least one program includes instructions for executing, by the electronic device 100, the methods according to the embodiments listed in claims and/or specification of the present invention.

According to various embodiments, an electronic device includes a memory and a processor, and the processor may control an operation of receiving data including IDentification information and control information, an operation of confirming the data and a value stored in a database of the electronic device, and an operation of performing a function corresponding to the control information according to the confirmed result.

According to various embodiments, an electronic device includes at least one processor, a touch screen, a memory, and at least one program stored in the memory and executed by the at least one processor, and the program includes an instruction for receiving data including IDentification information and control information, confirming the data and a value stored in a database of the electronic device, and performing a function corresponding to the control information according to the confirmed result.

Such programs (for example, software modules and software) may be stored in random access memory, non-volatile memory including flash memory, Read Only Memory (ROM), Electrically Erasable Programmable Read Only Memory (EEPROM), a magnetic disc storage device, Compact Disc-ROM (CD-ROM), Digital Versatile Discs (DVDs), or another form of an optical storage device, or a magnetic cassette. Such programs may also be stored in a memory configured with a combination of some or all of the above. Additionally, each configuration memory may be included in plurality.

In addition, such programs may be stored in an attachable storage device accessing the electronic device 100 through a communication network such as the Internet, intranet, LAN, WLAN or SAN or a communication network configured with a combination thereof. Such a storage device may access the electronic device 100 through an external port. Additionally, an additional storage device on a communication network may access the electronic device 100.

While the present invention has been shown and described with reference to certain embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method in an electronic device, the method comprising:
receiving, a message including control information corresponding to at least one function by broadcasted or multicasted from a second electronic device; and
performing at least one function corresponding to at least part of information in the message.

2. The method of claim 1, wherein receiving the message comprises receiving identification information of the second electronic device.

3. The method of claim 2, wherein receiving the message comprises receiving the identification information as part of the message.

4. The method of claim 2, wherein the message comprises at least one identification information on the second electronic device and at least one control information, such that the second electronic device provides an instruction and the first electronic device performs the instruction.

5. The method of claim 2, wherein the identification information comprises an identifier of the second electronic device or information on a service area for receiving the message.

6. The method of claim 1, wherein performing the at least one function comprises determining the at least one function on the basis of at least part of pre-stored information in the first electronic device.

7. The method of claim 6, wherein determining the at least one function comprises determining whether the first electronic device has an authority to transmit the message on the basis of the at least part of the pre-stored information.

8. The method of claim 6, wherein determining the at least one function comprises determining whether a function corresponding to the control information is a function authorized to receive a control from the second electronic device among at least one function provided from the first electronic device on the basis of the at least part of the pre-stored information.

9. The method of claim 1, wherein receiving the message comprises receiving the message through at least one of Infrared Data Association (IrDA) communication, Bluetooth communication, Wireless Fidelity (Wi-Fi) communication, Near Field Communication (NFC), or Zigbee communication.

10. A method in an electronic device for controlling functions in another electronic device, the method comprising:
generating, by a first electronic device, a message including at least one identification information on the first electronic device and control information corresponding to at least one function performed in a second electronic device; and
multicasting or broadcasting the message.

11. The method of claim 10, wherein the first electronic device controls the second electronic device thereby performing the at least one function through the second electronic device receiving the message.

12. The method of claim 11, wherein controlling the second electronic device comprises displaying a message of the first electronic device relating to performing the function on the second electronic device.

13. An electronic device:
a first electronic device including a memory storing identification information and control information, and at least one processor managing a control message,
wherein the processor receives a message including at least one of control information corresponding to at least one function by broadcasted or multicasted from a second electronic device and the identification information identifying the second electronic device, and is set to perform at least one function corresponding to at least part of information in the message.

14. The electronic device of claim 13, wherein the processor is set to confirm whether the identification information is authorized identification information to be stored in the memory.

15. The electronic device of claim 13, wherein the processor is set to confirm whether the control information is authorized control information to be stored in the memory when it is confirmed that the identification information is authorized identification information.

16. The electronic device of claim 13, wherein the first electronic device further comprises a display unit, and wherein the processor is set to display information related to a progress in performing the function on the display unit.

17. The electronic device of claim 13, wherein the processor is set to display that performing the operation is controlled by the second electronic device transmitting the message.

18. The electronic device of claim 13, wherein the processor generates a message including at least one identification information on the first electronic device and control information corresponding to at least one function performed by the second electronic device, and is set to multicast or broadcast the message to a plurality of electronic devices.

19. The electronic device of claim 13, wherein the processor transmits/receives the message through at least one of Infrared Data Association (IrDA) communication, Bluetooth communication, Wireless Fidelity (Wi-Fi) communication, Near Field Communication (NFC), or Zigbee communication.

20. A non-transitory computer readable recording medium having recorded thereon a program which when executed performs an operation of obtaining at least one of user information and environmental information, and an operation of determining an operation mode of an electronic device corresponding to at least one of the user information and the environmental information according to a property of the information, wherein the program includes an instruction for receiving a message including control information corresponding to at least one function broadcasted or multicasted from another electronic device and performing at least one function corresponding to at least part of information in the message.
